(19) United States
(12) Patent Application Publication
(10) Pub. No.: US 2026/0329302 A1
(43) Pub. Date: Oct. 22, 2026

(54) ELECTRONIC APPARATUS AND CONTROL METHOD THEREOF

(71) Applicant: SAMSUNG ELECTRONICS CO., LTD., Suwon-si (KR)

(72) Inventors: Jaeha LEE, Suwon-si (KR); Soonbeom KWON, Suwon-si (KR)

(73) Assignee: SAMSUNG ELECTRONICS CO., LTD., Suwon-si (KR)

(21) Appl. No.: 19/575,293

(22) Filed: Mar. 23, 2026

Related U.S. Application Data
(63) Continuation of application No. PCT/KR2026/002796, filed on Feb. 13, 2026.

(30) Foreign Application Priority Data
Apr. 22, 2025 (KR) 10-2025-0052092
Jul. 1, 2025 (KR) 10-2025-0088119

(51) Int. Cl. G05D 1/661; A47L 11/40; B60L 53/36; G05D 1/622; G05D 1/65; G06T 3/60; G06T 7/60; G06T 7/73; G06V 10/30; G06V 10/75; G06V 20/52; G06V 10/82; G06V 10/94

(52) U.S. Cl. CPC G05D 1/661; A47L 11/4011; A47L 11/4061; A47L 11/4091; B60L 53/36; G05D 1/622; G05D 1/65; G06T 3/60; G06T 7/60; G06T 7/75; G06V 10/30; G06V 10/751; G06V 20/52; A47L 2201/022; A47L 2201/04; B60L 2240/12; G06T 2207/10012; G06T 2207/10028; G06T 2207/20076; G06T 2207/20081; G06T 2207/20084; G06V 10/82; G06V 10/955

(57) ABSTRACT

An apparatus including: a driver; a sensor; memory storing instructions; and a processor, wherein the instructions cause the apparatus to: identify a first area within a distance from a location of a charger, identify a second area outside the first area, control the driver to move the apparatus at a first speed in the second area while returning to the charger, control the driver to move the apparatus at a second speed lower than the first speed upon entering the first area, based on not identifying the charger at the location of the charger within the first area, obtain images corresponding to different search areas through the sensor while rotating the sensor, based a candidate object being identified in the images, identify the charger by comparing information about the candidate object with pre-stored reference information, and control the driver to move the apparatus to a location of the identified charger.

### CROSS-REFERENCE TO RELATED APPLICATIONS

This application is a bypass continuation of International Application No. PCT/KR2026/002796, filed on Feb. 13, 2026, which is based on and claims priority to Korean Patent Application No. 10-2025-0052092, filed on Apr. 22, 2025 and Korean Patent Application No. 10-2025-0088119, filed on Jul. 1, 2025 in the Korean Intellectual Property Office, the disclosures of which are incorporated by reference herein in their entireties.

### BACKGROUND

### 1. Field

The present disclosure relates to an electronic apparatus and a control method thereof.

### 2. Description of Related Art

A charging station refers to a device used by a mobile robot or a cleaning robot to receive power autonomously. In general, the charging station may be located while being fixed at a specific location in a space. However, in recent years, a charging station in the form of a pad that is movable without being fixed has been developed.

In the related art, a location of the charging station may be identified by using an infrared (IR) signal, and the electronic apparatus may receive power by moving to the identified location of the charging station. However, as movable charging stations have developed, there is a limitation in detecting an accurate changed location of the charging station by using the IR signal and moving thereto when the location of the charging station is changed.

The above-described information may be provided as related art for assisting in understanding of the present disclosure. No claim or determination is made as to whether any of the above-described content is applicable as prior art related to the present disclosure.

### SUMMARY

Provided are an electronic apparatus for correcting and outputting an image and a control method thereof.

Additional aspects will be set forth in part in the following description, in part will be apparent from the description, or may be learned by execution of the embodiments presented.

According to an aspect of the disclosure, an electronic apparatus includes: a driver configured to move the electronic apparatus; a sensor; memory storing instructions; and at least one processor including processing circuitry, wherein the instructions, when executed by the at least one processor individually or collectively, cause the electronic apparatus to: identify a first area within a predetermined distance from a location of a charging station, identify a second area outside the first area, control the driver to move the electronic apparatus at a first speed in the second area while returning to the charging station, control the driver to move the electronic apparatus at a second speed lower than the first speed upon entering the first area, based on the charging station not being identified at the location of the charging station within the first area, obtain a plurality of images corresponding to different search areas through the sensor while rotating the sensor, based on at least one candidate object being identified in the plurality of images, identify the charging station among the at least one candidate object by comparing information about the at least one candidate object with pre-stored reference information, and control the driver to move the electronic apparatus to a location of the identified charging station.

The instructions, when executed by the at least one processor individually or collectively, may further cause the electronic apparatus to: obtain a plurality of point cloud images corresponding to different search areas through the sensor, based on the at least one candidate object being identified in the plurality of point cloud images, identify a point cloud image corresponding to the at least one candidate object among the plurality of point cloud images, obtain center point information and direction vector information for the at least one candidate object based on the identified point cloud image, and identify a first object among the at least one candidate object as the charging station by comparing the center point information and the direction vector information with the pre-stored reference information.

The reference information may include point cloud image information and feature point information for the charging station; and the instructions, when executed by the at least one processor individually or collectively, may further cause the electronic apparatus to: perform Iterative Closest Point (ICP) matching between the identified point cloud image and a point cloud image corresponding to the charging station by inputting the information about the at least one candidate object and the reference information into an ICP algorithm, and identify the charging station among the at least one candidate object based on a result of the ICP matching.

The instructions, when executed by the at least one processor individually or collectively, may further cause the electronic apparatus to: perform the ICP matching between a point cloud image corresponding to the first object and the point cloud image corresponding to the charging station and generate an ICP matching score, and based on the ICP matching score being equal to or greater than a threshold value, identify the first object as the charging station.

The instructions, when executed by the at least one processor individually or collectively, may further cause the electronic apparatus to: obtain transformation information for rotating the point cloud image corresponding to the charging station into a point cloud image corresponding to the first object based on the ICP matching, and identify a docking direction for docking the electronic apparatus to the identified charging station based on the transformation information.

The instructions, when executed by the at least one processor individually or collectively, may further cause the electronic apparatus to: obtain the plurality of point cloud images corresponding to different search areas, respectively, through the sensor, identify an object that is entirely included in one of the plurality of point cloud images as the at least one candidate object, and ignore an object that is only partially included in one of the plurality of point cloud images.

The instructions, when executed by the at least one processor individually or collectively, may further cause the electronic apparatus to: preprocess the identified point cloud image by voxelizing and spatial filtering the identified point cloud image, and obtain the center point information and the direction vector information for the at least one candidate object based on the preprocessed identified point cloud image.

The instructions, when executed by the at least one processor individually or collectively, may further cause the electronic apparatus to: identify an average position of all of a plurality of points of the identified point cloud image as the center point information, and identify the direction vector information based on a point, among the plurality of points, at a highest position in a vertical direction with respect to a ground, and a point, among the plurality of points, at a lowest position in the vertical direction.

The instructions, when executed by the at least one processor individually or collectively, may further cause the electronic apparatus to: based on the charging station not being identified at the location of the charging station within the first area, obtain obstacle information around the electronic apparatus through the sensor, and obtain the plurality of images corresponding to different search areas through the sensor while rotating the sensor in a direction with fewer obstacles based on the obstacle information.

The first area may be an area determined based on a sensing range of the sensor, and the first area and the second area may be adjacent to each other.

According to an aspect of the disclosure, a method of controlling an electronic apparatus includes: identifying a first area within a predetermined distance from a location of a charging station; identifying a second area outside the first area; moving the electronic apparatus at a first speed in the second area while returning to the charging station; moving the electronic apparatus at a second speed lower than the first speed upon the electronic apparatus entering the first area; based on the charging station not being identified at the location of the charging station within the first area, obtaining a plurality of images corresponding to different search areas while rotating the sensor; based on at least one candidate object being identified in the plurality of images, identifying the charging station among the at least one candidate object by comparing information about the at least one candidate object with pre-stored reference information; and moving the electronic apparatus to a location of the identified charging station.

The method may further include: obtaining a plurality of point cloud images corresponding to different search areas through a sensor of the electronic apparatus while rotating the sensor; based on the at least one candidate object being identified in the plurality of point cloud images, identifying a point cloud image corresponding to the at least one candidate object among the plurality of point cloud images; obtaining center point information and direction vector information for the at least one candidate object based on the identified point cloud image; and identifying a first object among the at least one candidate object as the charging station by comparing the center point information and the direction vector information with the pre-stored reference information.

The reference information may include point cloud image information and feature point information for the charging station, and the method may further include: performing Iterative Closest Point (ICP) matching between the identified point cloud image and a point cloud image corresponding to the charging station by inputting the information about the at least one candidate object and the reference information into an ICP algorithm; and identifying the charging station among the at least one candidate object based on a result of the ICP matching.

The may further include: performing the ICP matching between a point cloud image corresponding to the first object and the point cloud image corresponding to the charging station and generate an ICP matching score; and based on the ICP matching score being equal to or greater than a threshold value, identifying the first object as the charging station.

The method may further include: obtaining transformation information for rotating the point cloud image corresponding to the charging station into a point cloud image corresponding to the first object based on the ICP matching; and identifying a docking direction for docking the electronic apparatus to the identified charging station based on the transformation information.

The method may further include: obtaining the plurality of point cloud images corresponding to different search areas, respectively, through the sensor; identifying an object that is entirely included in one of the plurality of point cloud images as the at least one candidate object; and ignoring an object that is only partially included in one of the plurality of point cloud images.

According to an aspect of the disclosure, a non-transitory computer readable storage medium stores computer instructions that, when executed by at least one processor of an electronic apparatus, cause the electronic apparatus to perform a method of controlling the electronic apparatus, the method including: identifying a first area within a predetermined distance from a location of a charging station; identifying a second area outside the first area; moving the electronic apparatus at a first speed in the second area while returning to the charging station; moving the electronic apparatus at a second speed lower than the first speed upon the electronic apparatus entering the first area; based on the charging station not being identified at the location of the charging station within the first area, obtaining a plurality of images corresponding to different search areas while rotating the sensor; based on at least one candidate object being identified in the plurality of images, identifying the charging station among the at least one candidate object by comparing information about the at least one candidate object with pre-stored reference information; and moving the electronic apparatus to a location of the identified charging station.

With regard to the non-transitory computer readable storage medium, the method may further include: obtaining a plurality of point cloud images corresponding to different search areas through a sensor of the electronic apparatus while rotating the sensor; based on the at least one candidate object being identified in the plurality of point cloud images, identifying a point cloud image corresponding to the at least one candidate object among the plurality of point cloud images; obtaining center point information and direction vector information for the at least one candidate object based on the identified point cloud image; and identifying a first object among the at least one candidate object as the charging station by comparing the center point information and the direction vector information with the pre-stored reference information.

With regard to the non-transitory computer readable storage medium, the reference information may include point cloud image information and feature point information for the charging station, and the method may further include: performing Iterative Closest Point (ICP) matching between the identified point cloud image and a point cloud image corresponding to the charging station by inputting the information about the at least one candidate object and the reference information into an ICP algorithm; and identifying the charging station among the at least one candidate object based on a result of the ICP matching.

With regard to the non-transitory computer readable storage medium, the method may further include: performing the ICP matching between a point cloud image corresponding to the first object and the point cloud image corresponding to the charging station and generate an ICP matching score; and based on the ICP matching score being equal to or greater than a threshold value, identifying the first object as the charging station.

Other aspects and features of the present disclosure will become apparent to those skilled in the art from the following detailed description, which is provided with reference to the accompanying drawings.

### BRIEF DESCRIPTION OF THE DRAWINGS

The above and other aspects and features of certain embodiments of the present disclosure will become more apparent from the following description taken in conjunction with the accompanying drawings, in which:

FIG. 1 is a diagram illustrating an operation of an electronic apparatus according to at least one embodiment;

FIG. 2 is a block diagram illustrating a configuration of the electronic apparatus according to at least one embodiment;

FIG. 3 is a block diagram illustrating a detailed configuration of the electronic apparatus according to at least one embodiment;

FIG. 4 is a diagram illustrating a process in which the electronic apparatus identifies the first area and the second area according to at least one embodiment;

FIG. 5 is a diagram illustrating a process in which the electronic apparatus identifies a charging station at a changed location according to at least one embodiment;

FIG. 6 is a diagram illustrating a process in which an electronic apparatus identifies a rotation direction according to at least one embodiment;

FIG. 7 is a diagram illustrating a process in which the electronic apparatus obtains a point cloud image according to at least one embodiment;

FIG. 8 is a diagram illustrating a process in which the electronic apparatus identifies a candidate object according to at least one embodiment;

FIG. 9 is a diagram illustrating a process in which the electronic apparatus obtains reference information according to at least one embodiment;

FIGS. 10 and 11 are diagrams illustrating a process in which the electronic apparatus obtains center point information and direction vector information according to at least one embodiment;

FIG. 12 is a diagram illustrating an Iterative Closest Point (ICP) matching process of the electronic apparatus according to at least one embodiment;

FIG. 13 is a diagram illustrating a process in which the electronic apparatus obtains transformation information according to at least one embodiment;

FIG. 14 is a diagram illustrating a process in which the electronic apparatus is docked to the charging station according to at least one embodiment;

FIG. 15 is a flowchart illustrating an overall operation process of the electronic apparatus according to at least one embodiment; and

FIG. 16 is a flowchart illustrating a method for operating an electronic apparatus according to at least one embodiment.

It should be noted that the same reference numerals are used throughout drawings to indicate identical or similar elements, features and structures.

### DETAILED DESCRIPTION

General terms currently widely used are selected as terms used in one or more embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the present disclosure, an expression such as "have," "may have," "include," or "may include," indicates the presence of a corresponding feature (e.g., a numerical value, a function, an operation, or a component such as a part), and does not exclude the presence of an additional feature.

An expression such as "at least one of A and/or B" may be understood as indicating either "A or B" or "both of A and B."

Expressions such as "first" and "second" used in the present disclosure may indicate various components regardless of the sequence or importance of the components. The expression is used only to distinguish one component from another component, and does not limit the corresponding component.

When any component (e.g., a first component) is mentioned to be "(operatively or communicatively) coupled with/to" or "connected to" another component (e.g., a second component), it should be understood that the any component is directly coupled to another component or may be coupled to another component through yet another component (e.g., a third component).

A term of a singular number may include its plural number unless explicitly indicated otherwise in the context. It should be understood that a term "include" or "have" used in this application specifies the presence of features, numerals, steps, operations, components, parts, or combinations thereof, which are mentioned in the specification, and does not preclude the presence or addition of at least one other features, numerals, steps, operations, components, parts, or combinations thereof.

In the present disclosure, a "module" or a "~er/~or" may perform at least one function or operation, and be implemented by hardware, software, or a combination of hardware and software. In addition, a plurality of "modules" or a plurality of "~ers/~ors" may be integrated in at least one module and be implemented by the processor except for a "module" or a "~er/or" that needs to be implemented by a specific hardware.

In the present disclosure, a term such as a "user" may refer to a person who uses an electronic apparatus or a device used by the person.

Hereinafter, an embodiment of the present disclosure is described in more detail with reference to the accompanying drawings.

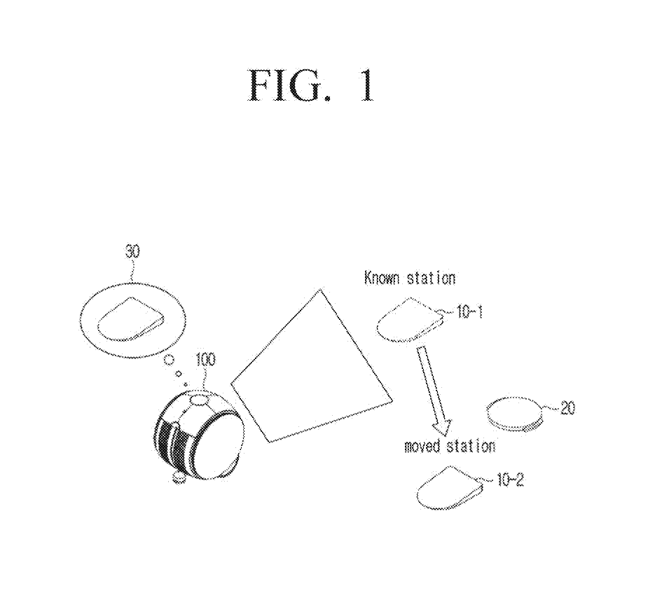

FIG. 1 is a diagram illustrating an operation of an electronic apparatus according to at least one embodiment.

According to at least one embodiment, an electronic apparatus 100 may be implemented as various electronic apparatuses such as a mobile robot, a cleaning robot, an automated guided vehicle (AGV), an autonomous mobile robot (AMR), a social robot, a projector, a portable projector, a tablet, a mobile device, or a laptop. In the present disclosure, for convenience of description, the electronic apparatus 100 is assumed to be a mobile robot.

According to at least one embodiment, the electronic apparatus 100 may identify a location of a charging station 10-1 and may control a driver 110 to travel to the location of the charging station 10-1 to perform charging. For example, the electronic apparatus 100 may generate an indoor map through a simultaneous localization and mapping (SLAM)-based sensor and may identify the location of the charging station based on the indoor map. For example, the electronic apparatus 100 may identify the location of the charging station based on an infrared (IR) signal or a wireless signal (e.g., a Bluetooth low energy (BLE) signal, an ultra-wideband (UWB) signal) received from the charging station.

The charging station 10-1 may be a movable device to supply power to the electronic apparatus 100. The charging station 10-1 may supply power to the electronic apparatus 100 that autonomously approaches and is docked thereto. For example, the charging station may supply power to the electronic apparatus 100 that is docked due to insufficient remaining battery capacity.

For example, the charging station 10-1 may be located on a floor surface without being fixed to a specific area in a space. For example, the charging station 10-1 may be located on a floor surface without being fixed to a corner or in front of a wall in a space in which the electronic apparatus 100 may travel. Without being limited thereto, the charging station 10-1 may be referred to as a docking station, a charging pad, or a power station, and is collectively referred to as the charging station in the present disclosure.

According to at least one embodiment, when the location of the charging station 10-1 is identified, the electronic apparatus 100 may store the identified location of the charging station 10-1 in memory 130. When charging is required, the electronic apparatus 100 may control the driver 110 to travel to a location of the existing charging station (or a previous station) based on the location of the charging station 10-1 that is stored in memory 130.

As a result of traveling to the location of the existing charging station based on the location of the charging station that is stored in the memory 130, the electronic apparatus 100 may encounter a situation in which the charging station is not identified at the existing location. For example, as the charging station is movable, the location of the charging station may be changed by a user, either mistakenly or intentionally. For example, the location of the charging station may be intentionally changed for convenience of user movement.

According to at least one embodiment, when the charging station is not identified at the location of the existing charging station, the electronic apparatus 100 may identify a plurality of objects 10-2 and 20 located around the electronic apparatus through a sensor 120, and may identify a charging station 10-2 among the plurality of objects 10-2 and 20. In this case, the electronic apparatus 100 may identify the charging station 10-2 among the plurality of objects 10-2 and 20 based on reference information 30 stored in the memory 130.

Referring to FIG. 1, the electronic apparatus 100 may control the driver 110 to travel to the location of the existing charging station 10-1. The electronic apparatus 100 may lower a traveling speed and may sense the charging station through the sensor 120 when the electronic apparatus 100 reaches a predetermined distance from the location of the existing charging station 10-1.

The electronic apparatus 100 may sense a surrounding space through the sensor 120 while rotating in place when the charging station 10-1 is not identified at the location of the existing charging station based on a sensing result. The electronic apparatus 100 may identify the plurality of objects 10-2 and 20 located around the electronic apparatus and may identify the charging station 10-2 by comparing each of the plurality of objects 10-2 and 20 with the pre-stored reference information 30. That is, the electronic apparatus 100 may identify the charging station 10-2 at a changed location from the existing location.

Hereinafter, a method in which the electronic apparatus 100 identifies the charging station at a changed location based on a distance from the location of the existing charging station will be described with reference to the drawings.

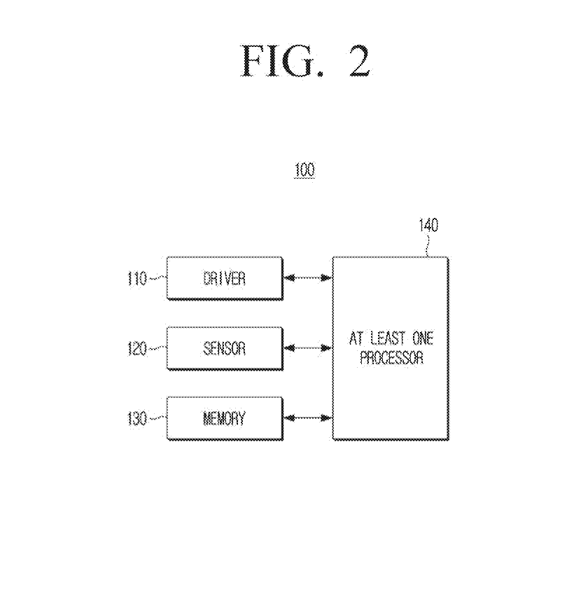

FIG. 2 is a block diagram illustrating a configuration of the electronic apparatus according to at least one embodiment.

Referring to FIG. 2, the electronic apparatus 100 may include the driver 110, the sensor 120, the memory 130, and at least one processor 140. However, the present disclosure is not limited thereto, and the electronic apparatus 100 may be implemented by omitting some components or further including other components.

The driver 110 refers to a component for moving a body of the electronic apparatus 100. The driver 110 may include a plurality of wheels, driving motors for rotating the plurality of wheels, gears, shafts, or the like. The plurality of wheels may be disposed at a lower side or a side surface of the body of the electronic apparatus 100 and may support the body of the electronic apparatus 100 from a floor surface. When the driving motors operate and a driving force is transmitted to the plurality of wheels to rotate each wheel, the electronic apparatus 100 may move by friction between the floor surface and the wheels. In addition, when a direction change is performed, the driver 110 may change a rotational speed of at least one of the plurality of wheels or may adjust an alignment direction of the wheels. An endless track may be used instead of the wheels depending on types of the electronic apparatus 100 or characteristics of a space in which the electronic apparatus 100 is located (e.g., roughness or friction of the floor surface).

The sensor 120 refers to a component for identifying a charging station among a plurality of objects while moving through a space. The sensor 120 may include at least one of a depth camera, a light detection and ranging (LiDAR) sensor, an inertial measurement unit (IMU) sensor, a time of flight (ToF) sensor, a vision sensor, an optical sensor, a red-green-blue (RGB) sensor, an image sensor, an infrared (IR) sensor, an ultrasonic sensor, a gyro sensor, an acceleration sensor, or a proximity sensor.

A depth camera refers to a sensor that senses depth data by stereoscopically measuring a distance to an external object by projecting a laser or infrared ray onto the external object and receiving returning light by using a stereo camera. A LiDAR sensor may output sensing information for obtaining information about distances to various surrounding objects (e.g., walls, furniture, or home appliances) by projecting light (e.g., laser, near-infrared light, visible light, or ultraviolet light) in 360 degrees around the surroundings and detecting light reflected from the surrounding objects. An IMU sensor refers to a sensor for detecting movement of the electronic apparatus and may include at least one of a geomagnetic sensor, an acceleration sensor, or a gyro sensor. A ToF sensor may measure a distance to an external object by outputting a signal such as a laser and using a time at which the reflected signal is then received (i.e., a time-of-flight).

The memory 130 may store at least one instruction, data, program, or the like required for operating the electronic apparatus 100. For example, the memory 130 may store the reference information on the charging station.

The memory 130 may be implemented as memory embedded in the electronic apparatus 100 or may be implemented as memory detachable from the electronic apparatus 100 depending on a data storage purpose. For example, data for driving the electronic apparatus 100 may be stored in the memory embedded in the electronic apparatus 100, and data for an extended function of the electronic apparatus 100 may be stored in the memory detachable from the electronic apparatus 100.

The memory embedded in the electronic apparatus 100 may be implemented as at least one of volatile memory (e.g., dynamic RAM (DRAM), static RAM (SRAM), or synchronous dynamic RAM (SDRAM)) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), a hard drive, or a solid state drive (solid state drive (SSD)).

The memory 130 may be implemented as single memory that stores data generated in various operations according to the present disclosure. However, the present disclosure is not limited thereto, and the memory 130 may be implemented to include a plurality of memories that may store different types of data or may store data generated in different stages.

At least one processor 140 may control an overall operation of the electronic apparatus 100. In detail, at least one processor 140 may control an overall operation of the electronic apparatus 100 by being connected to respective components of the electronic apparatus 100. For example, at least one processor 140 may control an overall operation of the electronic apparatus 100 by being electrically connected to the driver 110, the sensor 120, and the memory 130. At least one processor 140 may include processing circuitry and may include one or more processors.

At least one processor 140 may perform operations of the electronic apparatus 100 according to the one or more embodiments by executing at least one instructions stored in the memory 130.

At least one processor 140 may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. At least one processor 140 may control at least one other component included in the electronic apparatus or any combination thereof and may perform operations related to communication or data processing. At least one processor 140 may execute at least one program or instruction stored in the memory. For example, at least one processor may perform a method according to at least one embodiment of the present disclosure by executing at least one instruction stored in the memory.

When the method according to at least one embodiment of the present disclosure includes a plurality of operations, the plurality of operations may be performed by one processor or may be performed by a plurality of processors. For example, when a first operation, a second operation, and a third operation are performed by the method according to at least one embodiment, all of the first operation, the second operation, and the third operation may be performed by a first processor, and the first operation and the second operation may be performed by the first processor (e.g., a general-purpose processor) and the third operation may be performed by a second processor (e.g., an artificial intelligence-specific processor).

At least one processor 140 may be implemented as a single-core processor including a single core, or may be implemented as at least one multicore processor including multiple cores (for example, homogeneous multiple cores or heterogeneous multiple cores). If at least one processor 140 is implemented as the multicore processor, each of the multiple cores included in the multicore processor may include a processor internal memory such as a cache memory or an on-chip memory, and a common cache shared by the multiple cores may be included in the multicore processor. In addition, each (or some) of the multiple cores included in the multicore processor may independently read and perform a program instruction for implementing the method according to at least one embodiment of the present disclosure, or all (or some) of the multiple cores may be linked with each other to read and perform the program instruction for implementing the method according to at least one embodiment of the present disclosure.

When the method according to at least one embodiment of the present disclosure includes the plurality of operations, the plurality of operations may be performed by the single core among the multiple cores included in the multicore processor, or may be performed by the multiple cores. For example, if the first operation, the second operation, and the third operation are performed using the method according to at least one embodiment, the first operation, the second operation, and the third operation may all be performed by a first core included in the multicore processor. Alternatively, the first operation and the second operation may be performed by the first core included in the multicore processor, and the third operation may be performed by a second core included in the multicore processor.

In the embodiments of the present disclosure, the processor may indicate a system-on-chip (SoC) in which at least one processor and other electronic components are integrated with each other, the single-core processor, the multicore processor, or the core included in the single-core processor or the multicore processor. Here, the core may be implemented as the CPU, the GPU, the APU, the MIC, the DSP, the NPU, the hardware accelerator, the machine learning accelerator, or the like. However, the embodiments of the present disclosure are not limited thereto. Hereinafter, for convenience of description, at least one processor 140 is referred to as the processor 140.

According to at least one embodiment, the processor 140 may identify a first area within the predetermined distance from the location of the existing charging station and a second area outside the first area.

The location of the existing charging station may refer to a location of the charging station to which the electronic apparatus 100 is initially docked. The electronic apparatus 100 may store the location of the charging station to which the electronic apparatus 100 is initially docked in the memory 130, and in a subsequent operation, when returning to the charging station, the electronic apparatus 100 may control the driver 110 to travel to the location of the existing charging station based on the location of the charging station that is stored in the memory.

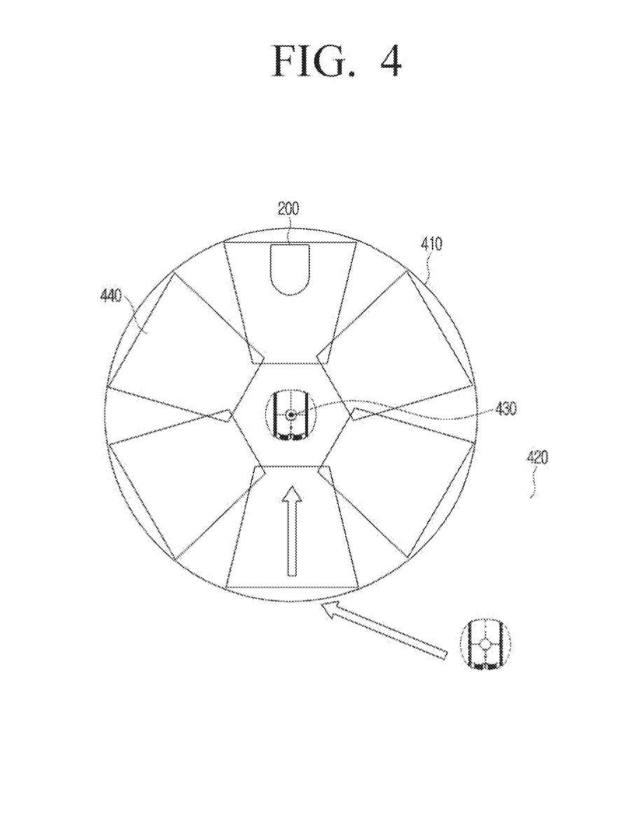

The first area may be an area set based on the sensing range of the sensor 120. The second area may be an area excluding the first area. The first area and the second area may be areas adjacent to each other. The first area and the second area may be specifically described with reference to FIG. 4.

According to at least one embodiment, the processor 140 may control the driver 110 to travel at a first speed in the second area while returning to the existing charging station. For example, the first speed may refer to a default traveling speed of the electronic apparatus 100.

According to at least one embodiment, the processor 140 may control the driver 110 to travel at a second speed lower than the first speed upon the electronic apparatus 100 entering the first area. For example, the second speed may be a low traveling speed of the electronic apparatus 100.

According to at least one embodiment, the processor 140, based on the charging station not being identified at the location of the existing charging station within the first area, may obtain a plurality of images corresponding to different search areas through the sensor 120 while rotating.

The search area may refer to an area set based on the field of view and sensing distance of the sensor 120. For example, the search area may refer to an area that the electronic apparatus 100 may sense in a specific direction in which the electronic apparatus 100 faces forward. In the present disclosure, the search area is illustrated as having a trapezoidal shape, which is merely at least one embodiment, and the present disclosure is not limited thereto.

According to at least one embodiment, based on at least one candidate object (or candidate cluster) being identified in the plurality of images, the processor 140 may identify the charging station among at least one candidate object by comparing information about at least one candidate object with the pre-stored reference information.

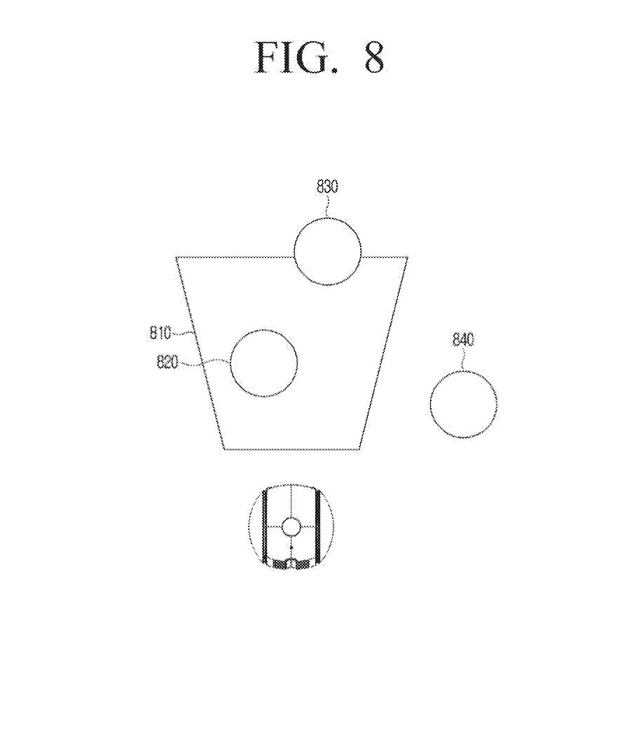

For example, the processor 140 may identify a plurality of objects in a plurality of images. Each of the plurality of objects may be entirely included in each of the plurality of images or may be partially included in each of the plurality of images. In this case, the processor 140 may identify only an object entirely included in each of the plurality of images as the candidate object. A detailed description thereof is provided with reference to FIG. 8.

According to at least one embodiment, the processor 140 may control the driver 110 to travel to the location of the identified charging station.

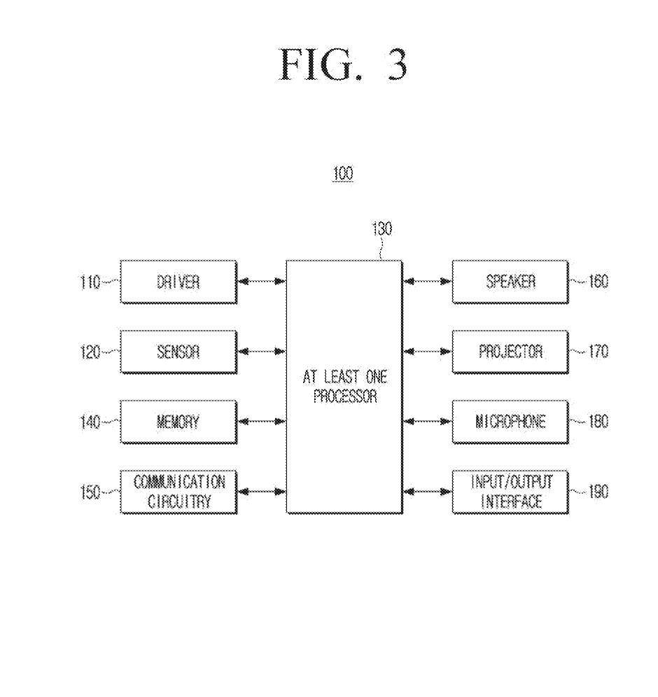

FIG. 3 is a block diagram illustrating a detailed configuration of the electronic apparatus according to at least one embodiment.

Referring to FIG. 3, the electronic apparatus 100 may include the driver 110, the sensor 120, the memory 130, at least one processor 140, communication circuitry 150, a speaker 160, a projector 170, a microphone 180, and an input/output interface 190. Descriptions of components overlapping with those illustrated in FIG. 2 are omitted.

The communication circuitry 150 may include wired or wireless input/output interfaces (or input/output terminals) according to various standards. The communication circuitry 150 refers to a component for performing communication with various types of external devices according to various types of communication schemes. The communication circuitry 150 may include a wireless communication module or a wired communication module. Here, each communication module may be implemented as at least one hardware chip.

The communication circuitry 150 may include various interfaces such a high definition multimedia interface (HDMI), a mobile high-definition link (MHL), a universal serial bus (USB), a DisplayPort (DP), Thunderbolt, a video graphics array (VGA) port, a red-green-blue (RGB) port, a D-subminiature (D-SUB), or a digital visual interface (DVI), Bluetooth, Zigbee, wired/wireless local area network (LAN), wide area network (WAN), Ethernet, IEEE 1394, Audio engineering society/European broadcasting union (AES/EBU) communication, optical communication, or coaxial communication.

The speaker 160 may convert a digital audio signal processed by the processor 140 into an analog audio signal and may amplify and output the analog audio signal. For example, the speaker 160 may include at least one speaker unit, a digital-to-analog (D/A) converter, an audio amplifier, or the like, which may output at least one channel.

The projector 170 may perform various functions under control of the processor 140. For example, the projector 170 may adjust a focus of an image based on a distance from a floor surface (e.g., a projection distance) or may perform a keystone correction function. The keystone correction function may indicate a function of correcting a distorted image. For example, when distortion of an image occurs in a left-right direction, the projector 170 may perform a horizontal keystone correction, and when distortion of an image occurs in an up-down direction, the projector 170 may perform a vertical keystone correction. In addition, when corners of an area are not aligned, the projector 170 may perform a quick-corner keystone correction to correct the imbalance.

The microphone 180 refers to a component for receiving a user voice or another sound and to convert the sound into audio data. The processor 140 may control the projector 170 based on a user voice signal received through the microphone 180.

The input/output interface 190 may be any one of a high definition multimedia interface (HDMI), a mobile high-definition link (MHL), a universal serial bus (USB), a DisplayPort (DP), Thunderbolt, a video graphics array (VGA) port, a red-green-blue (RGB) port, a D-subminiature (D-SUB), or a digital visual interface (DVI).

The input/output interface 190 may input or output at least one of an audio signal or a video signal. According to an implementation example, the input/output interface 190 may include a port for inputting or outputting only an audio signal and a port for inputting or outputting only a video signal as separate ports, or may be implemented as a single port for inputting or outputting both an audio signal and a video signal.

The input/output interface 190 may be connected to the communication circuitry 150. The input/output interface 190 may transmit information received from an external device to the communication circuitry or may transmit information received through the communication circuitry to the external device.

FIG. 4 is a diagram illustrating a process in which the electronic apparatus identifies the first area and the second area according to at least one embodiment.

According to at least one embodiment, the electronic apparatus 100 may identify the first area and the second area based on the location of the existing charging station. For example, the electronic apparatus 100 may identify a first area 410 within the predetermined distance from an initial location 430 (hereinafter referred to as point "a") at which a charging station 200 begins to be detected based on a predetermined sensing range 440.

For example, when the charging station 200 is initially identified at point "a," the electronic apparatus 100 may identify the first area 410 in a circular shape having the predetermined distance from point "a" as a radius.

For example, the predetermined distance may refer to a range determined based on a detection range (or sensing range) of the sensor 120. For example, the predetermined distance may be 0.5 m, which is merely an embodiment, and the present disclosure is not limited thereto.

According to at least one embodiment, the electronic apparatus 100 may identify the first area within the predetermined distance from the initial location of the charging station at which the charging station is initially located.

According to at least one embodiment, the electronic apparatus 100 may identify the second area 420 excluding the first area 410. The second area 420 may be an area outside the first area 410 and may be adjacent to the first area 410.

According to at least one embodiment, the electronic apparatus 100 may store information about the first area 410 and the second area 420 in the memory 130.

Referring to FIG. 4, the electronic apparatus 100 may identify the first area 410 within the predetermined distance from the location at which the charging station 200 is initially detected through the sensor 120, that is, point "a." For example, the electronic apparatus 100 may identify the first area 410 in a circular shape having 0.5 m as a radius from point "a." The electronic apparatus 100 may identify an area outside the first area 410 as the second area 420.

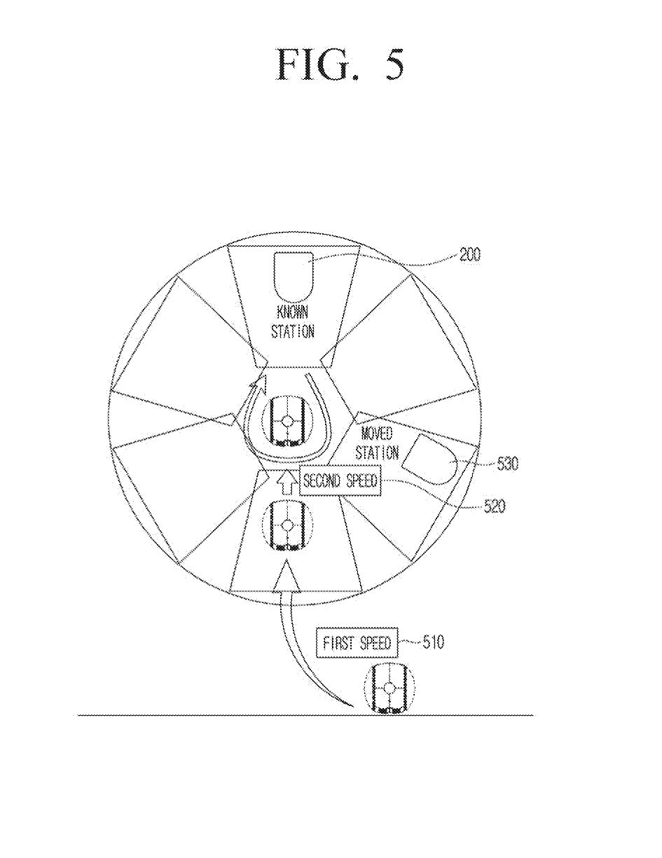

FIG. 5 is a diagram illustrating a process in which the electronic apparatus identifies the charging station at a changed location according to at least one embodiment.

According to at least one embodiment, the electronic apparatus 100 may control the driver 110 to travel at the first speed in the second area and at the second speed in the first area.

For example, while the electronic apparatus 100 returns to the location of the existing charging station 200, the electronic apparatus 100 may travel at a first speed 510, which is a default traveling speed, in the second area 420, and when the electronic apparatus 100 reaches the first area 410, the electronic apparatus 100 may control the driver 110 to travel at a second speed 520, which is a low traveling speed lower than the first speed 510.

According to at least one embodiment, when the charging station is not identified at the location of the existing charging station, the electronic apparatus 100 may identify a plurality of objects located in a surrounding space through the sensor 120 while rotating. For example, the electronic apparatus 100 may sense the surrounding space through the sensor 120 while rotating clockwise or counterclockwise from point "a." In one or more embodiments, the entire electronic apparatus 100 rotates, which thereby rotates the sensor 120. In another embodiment, only the sensor 120 rotates, for example by means of a separately rotatable portion.

Referring to FIG. 5, the electronic apparatus 100 may control the driver 110 to travel at the first speed 510 while traveling in the second area 420 based on the information about the first area 410 and the second area 420 that is stored in the memory 130. The electronic apparatus 100 may control the driver 110 to travel at the second speed 520 when the electronic apparatus 100 reaches the first area 410.

The electronic apparatus 100 may identify the charging station while traveling at the second speed 520 from the first area 410 to the position a 430. When the charging station is not identified at the location of the existing charging station 200, the electronic apparatus 100 may identify the charging station 530 at a changed location while rotating clockwise or counterclockwise from point "a."

However, the electronic apparatus 100 may determine whether to preferentially rotate in the clockwise or counterclockwise direction at the position a 430 based on information about obstacles located around point "a."

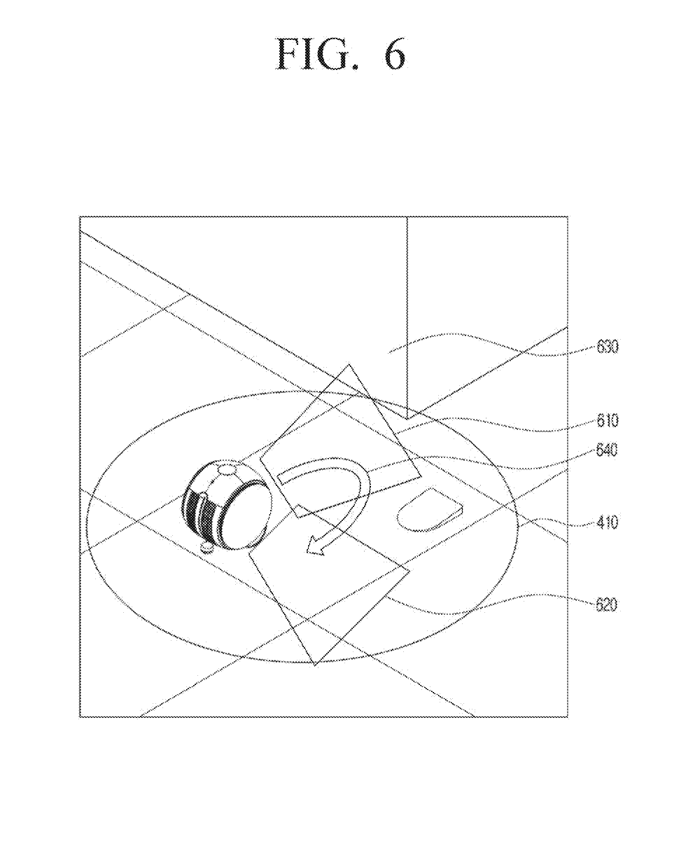

FIG. 6 is a diagram illustrating a process in which an electronic apparatus identifies a rotation direction according to at least one embodiment.

According to at least one embodiment, based on the charging station not being identified at the location of the existing charging station within the first area 410, the electronic apparatus 100 may obtain the obstacle information around the electronic apparatus 100 through the sensor 120.

The obstacle information may include information about an object having a predetermined size or greater. The obstacle information may refer to information about an object excluding the charging station and an object having a size similar to the charging station. For example, the obstacle information may refer to information about an object such as a wall or a pillar. The electronic apparatus 100 may identify, as the obstacle information, an object having a size beyond the search area, or walls, pillars, and objects in a space.

According to at least one embodiment, the electronic apparatus 100 may obtain a plurality of images corresponding to different search areas through the sensor 120 while preferentially rotating in a direction with fewer obstacles based on the obstacle information.

Referring to FIG. 6, the electronic apparatus 100 may obtain the obstacle information about a surrounding space while traveling to position a. For example, the electronic apparatus 100 may obtain obstacle information 630 about a wall on a left side of position a. When the charging station is not identified at the location of the existing charging station, i.e., at position a, the electronic apparatus 100 may compare the obstacle information included in a left search area 610 and a right search area 620. When the obstacle information 630 about a wall is included in the left search area 610, the electronic apparatus 100 may identify a clockwise direction 640 as a direction with fewer obstacles at position "a."

The electronic apparatus 100 may obtain a plurality of images corresponding to different search areas through the sensor 120 while preferentially rotating in the clockwise direction 640.

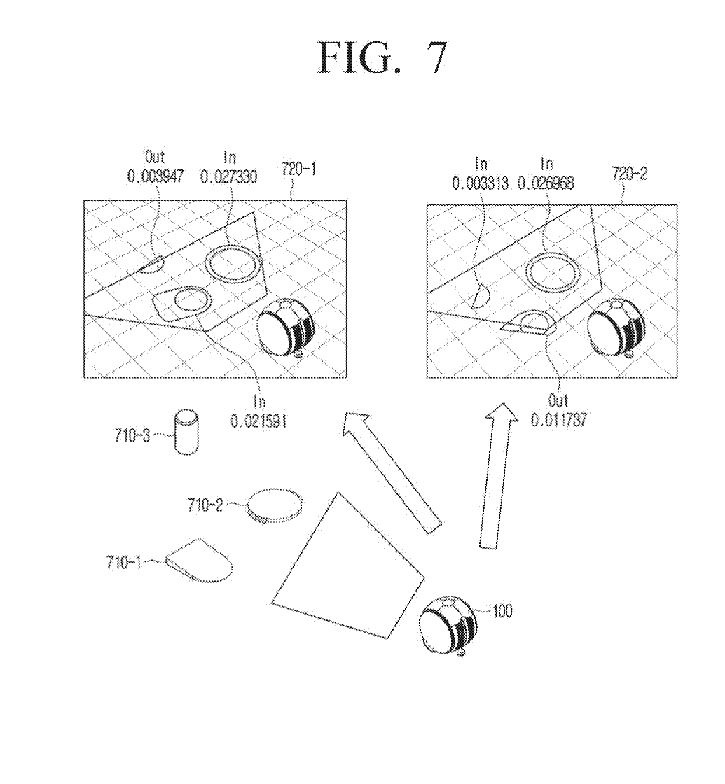

FIG. 7 is a diagram illustrating a process in which the electronic apparatus obtains a point cloud image according to at least one embodiment.

According to at least one embodiment, the electronic apparatus 100 may obtain the plurality of point cloud images corresponding to different search areas through the sensor. For example, the electronic apparatus 100 may obtain the plurality of point cloud images corresponding to different search areas in different directions through a depth camera.

A point cloud image may refer to a three-dimensional image including points in a space. The point cloud image may refer to an image including a plurality of points having (x, y, z) coordinates in a three-dimensional space.

According to at least one embodiment, the electronic apparatus 100 may obtain a plurality of point cloud images including at least one object. Based on at least one object being identified in the plurality of point cloud images, the electronic apparatus 100 may identify a point cloud image corresponding to at least one object.

According to at least one embodiment, when at least one object is identified as at least one candidate object, the electronic apparatus 100 may identify a point cloud image corresponding to at least one candidate object. The electronic apparatus 100 may perform preprocessing by voxelizing and spatial filtering the point cloud image corresponding to at least one candidate object.

Voxelization may refer to an operation for transforming a point cloud into a three-dimensional grid structure. Voxelization may refer to an operation for dividing an entire space into grid structures having a predetermined size and for replacing points included in each grid structure with one representative point. Spatial filtering may refer to an operation for selecting or removing only points within a specific spatial range from a point cloud.

For example, the electronic apparatus 100 may perform preprocessing including voxelization and spatial filtering on a point cloud image. For example, the electronic apparatus 100 may remove point clouds such as walls or pillars included in the point cloud image and may perform voxelization and spatial filtering.

As a result, the electronic apparatus 100 may remove unnecessary point clouds and may obtain a point cloud image corresponding to an object.

Referring to FIG. 7, the electronic apparatus 100 may identify a plurality of objects 710-1 to 710-3 located around the electronic apparatus 100 through the sensor 120 while rotating. The electronic apparatus 100 may obtain point cloud images 720-1 and 720-2 including the plurality of objects 710-1 to 710-3 through the sensor 120.

The electronic apparatus 100 may identify an object entirely or partially included within the search area based on the point cloud images 720-1 and 720-2.

FIG. 8 is a diagram illustrating a process in which the electronic apparatus identifies a candidate object according to at least one embodiment.

According to at least one embodiment, the electronic apparatus 100 may obtain a plurality of point cloud images respectively corresponding to different search areas through the sensor 120 and may identify the candidate object among a plurality of objects included in the plurality of point cloud images.

According to at least one embodiment, the electronic apparatus 100 may identify an object entirely included in one point cloud image 810 among the plurality of point cloud images as at least one candidate object. The entirely included object may be a specific object whose point cloud is entirely included within a search area 810.

According to at least one embodiment, the electronic apparatus 100 may ignore an object that is only partially included in one point cloud image 810 among the plurality of point cloud images. The partially included object may be a specific object whose point cloud is only partially included within the search area 810.

In FIG. 8, for convenience of description, the point cloud image is assumed to be the same image as the search area, that is, as having a trapezoidal shape.

Referring to FIG. 8, the electronic apparatus 100 may identify that two objects 820 and 830 are included in one point cloud image 810. Among these objects, the electronic apparatus 100 may identify the object 820 as the candidate object, as the object 820 is entirely included in the point cloud image 810. In contrast, the electronic apparatus 100 may ignore the object 830, as the object 830 is only partially included in the point cloud image 810.

The electronic apparatus 100 may ignore the object 840 as the object 840 is not included in the point cloud image 810 illustrated in FIG. 8. However, the electronic apparatus 100 may identify the object 840 as the candidate object as a point cloud image in a right-hand direction with respect to the electronic apparatus 100 includes the object 840.

When an object (e.g., the object 830) that is only partially included in the point cloud image 810 is also identified as the candidate object, the electronic apparatus 100 may misidentify a partial portion of a specific object as the charging station, thus increasing a probability of mismatching between the candidate object and the reference information.

For example, the electronic apparatus 100 may misidentify the partially included object as the charging station when a point cloud image corresponding to a portion of an object partially included in a point cloud image is similar to a point cloud image corresponding to an object identified as the charging station. Accordingly, to prevent such a case, the electronic apparatus 100 may identify only an object entirely included in a point cloud image as a candidate object.

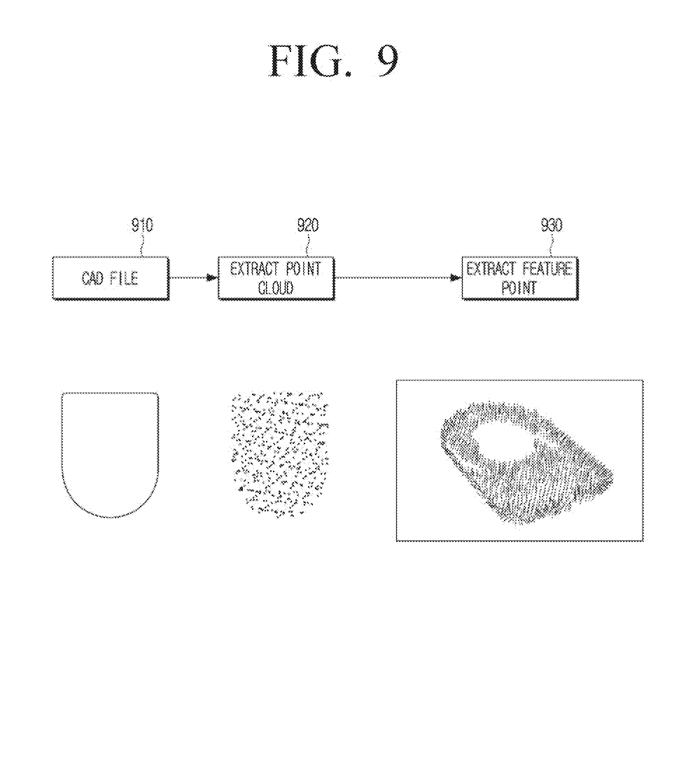

FIG. 9 is a diagram illustrating a process in which the electronic apparatus obtains the reference information according to at least one embodiment.

According to at least one embodiment, the electronic apparatus 100 may pre-store the reference information 30 corresponding to the charging station in the memory 130. The reference information 30 may include point cloud image information and feature point information for the charging station.

The point cloud image information may include a point cloud image, center point information, and direction vector information. The feature point information may include area information, thickness information, and main direction information of a point cloud corresponding to the charging station.

Referring to FIG. 9, the electronic apparatus 100 may store image information corresponding to the charging station in the memory 130 by using a computer-aided design (CAD) file 910. The electronic apparatus 100 may obtain a point cloud image 920 from image information corresponding to the charging station. The electronic apparatus 100 may extract a feature point 930 from the point cloud image 920.

The electronic apparatus 100 may store the reference information 30 in the memory and may identify the charging station among at least one candidate object by comparing the information about at least one candidate object with the reference information.

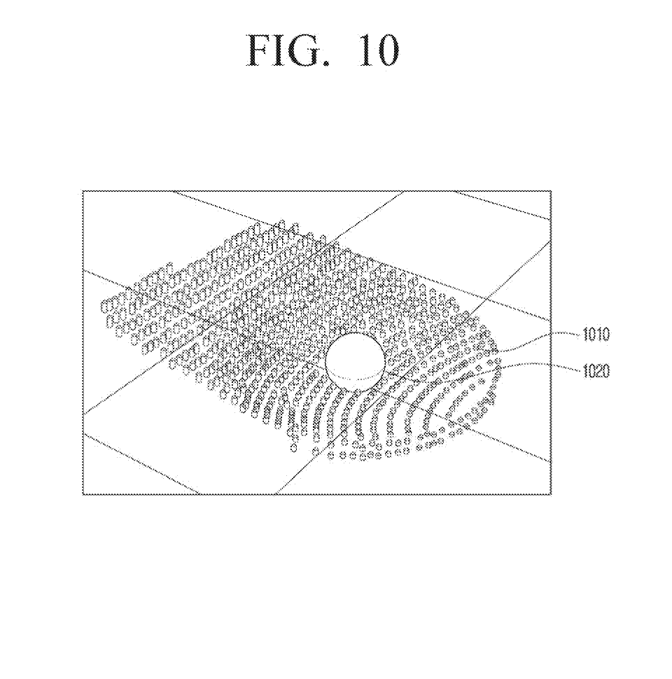

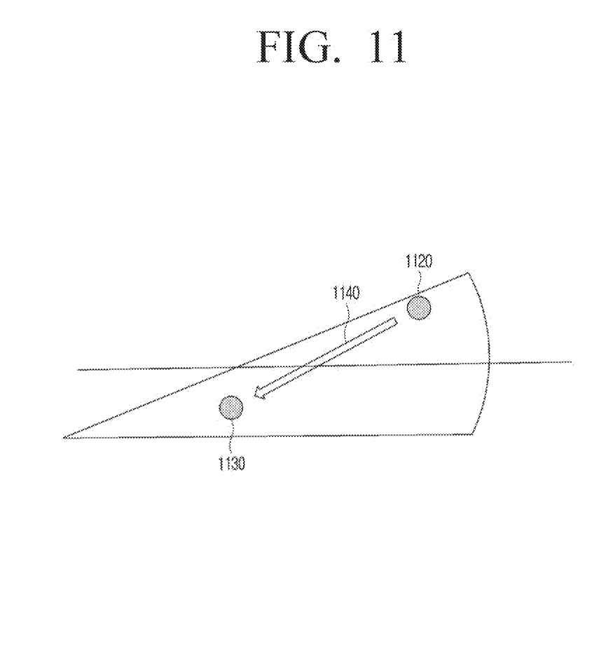

FIGS. 10 and 11 are diagrams illustrating a process in which the electronic apparatus obtains center point information and direction vector information according to at least one embodiment.

According to at least one embodiment, the electronic apparatus 100 may obtain center point information 1020 and direction vector information for at least one candidate object based on a point cloud image corresponding to at least one candidate object. In detail, the electronic apparatus 100 may obtain the center point information 1020 and the direction vector information 1140 for at least one candidate object based on the preprocessed point cloud image.

The center point information 1020 may include information corresponding to an average position for a plurality of points in a point cloud consisting of the plurality of points. The center point information 1020 may refer to information including location information of a candidate object (or cluster) in a space.

The direction vector information 1140 may include information about a direction of the candidate object (or cluster). The direction vector information 1140 may include information about an angle in the point cloud including a plurality of points.

According to at least one embodiment, in the point cloud image 1010 corresponding to at least one candidate object consisting of a plurality of points, the electronic apparatus 100 may identify an average position for all of a plurality of points as the center point information 1020.

Referring to FIG. 10, the electronic apparatus 100 may identify location information for each of the plurality of points in the point cloud image 1010 corresponding to at least one candidate object consisting of the plurality of points. The electronic apparatus 100 may identify the average position of all of the plurality of points as the center point information 1020 for the candidate object.

According to at least one embodiment, the electronic apparatus 100 may identify the direction vector information based on a point at a highest position and a point at a lowest position in a vertical direction with respect to the ground among the plurality of points.

For example, the electronic apparatus 100 may divide a three-dimensional (3D) point cloud into two parts based on a median value between a point at the highest position and a point at the lowest position in the vertical direction with respect to the ground.

The electronic apparatus 100 may identify a center point 1120 of a point cloud located at an upper side and a center point 1130 of a point cloud located at a lower side among the two divided point clouds. The electronic apparatus 100 may identify the direction vector information 1140 based on the center point 1120 of the point cloud located at the upper side and the center point 1130 of the point cloud located at the lower side.

Referring to FIG. 11, the electronic apparatus 100 may identify a median value (e.g., a z value of 4) between a point at the highest position in the vertical direction with respect to the ground (e.g., a z value of 8) and a point at the lowest position (e.g., a z value of 0). The electronic apparatus 100 may divide a point cloud corresponding to the candidate object into two parts based on the identified median value. The electronic apparatus 100 may obtain the direction vector information 1140 for the candidate object based on the center point 1120 of the point cloud located at the upper side and the center point 1130 of the point cloud located at the lower side among the two divided point clouds.

According to at least one embodiment, the electronic apparatus 100 may identify a first object among at least one candidate object as the charging station by comparing the center point information 1020 and the direction vector information 1140 with the pre-stored reference information 30.

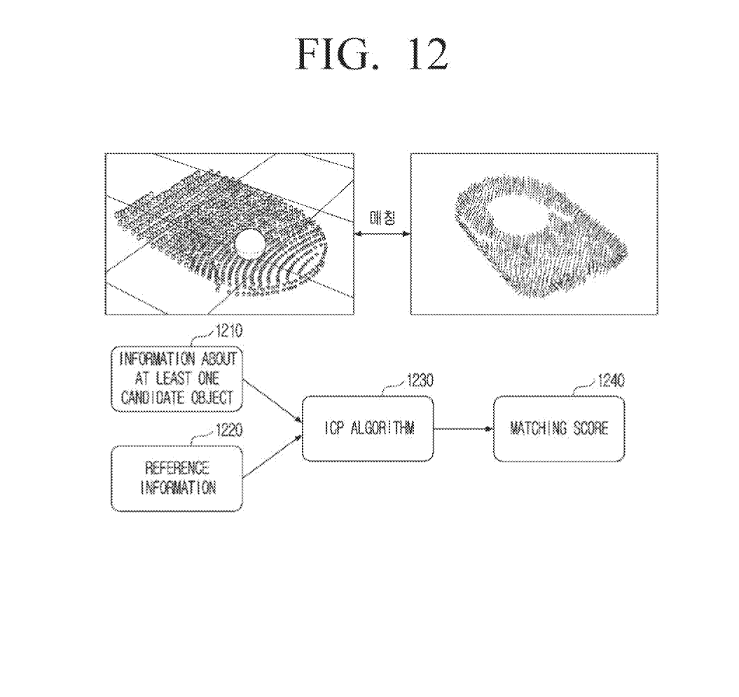

FIG. 12 is a diagram illustrating an Iterative Closest Point (ICP) matching process of the electronic apparatus according to at least one embodiment.

According to at least one embodiment, the electronic apparatus 100 may perform ICP matching between a point cloud image corresponding to at least one candidate object and a point cloud image corresponding to the charging station based on an Iterative Closest Point (ICP) algorithm 1230.

The ICP algorithm 1230 may refer to an iterative transformation algorithm for aligning a source point cloud to a target point cloud by arranging a plurality of points. The ICP algorithm 1230 may refer to an algorithm that arranges any one of the plurality of points based on an initial setting value when the initial setting value is input, and rotates and/or moves the source point cloud to align with the target point cloud. As the ICP algorithm belongs to the related art, a detailed description thereof is omitted.

According to at least one embodiment, the electronic apparatus 100 may perform the ICP matching between the point cloud image corresponding to at least one candidate object and the point cloud image corresponding to the charging station by inputting information 1210 about at least one candidate object and reference information 1220 into the ICP algorithm 1230.

According to at least one embodiment, the electronic apparatus 100 may identify the charging station among at least one candidate object based on a result of the ICP matching.

For example, the electronic apparatus 100 may perform the ICP matching between a point cloud image corresponding to the first object and a point cloud image corresponding to the charging station, and may identify a matching score 1240 based on the ICP matching. The electronic apparatus 100 may identify the first object as the charging station when the matching score 1240 is equal to or greater than a threshold value.

Referring to FIG. 12, the electronic apparatus 100 may input, into the ICP algorithm, the center point information and the direction vector information among the information 1210 about candidate objects as the initial setting values. The electronic apparatus 100 may input the information 1210 about candidate objects and the reference information 1220 into the ICP algorithm 1230 and may identify the matching score 1240 based on the ICP matching.

Based on a matching score being equal to or greater than the threshold value, the electronic apparatus 100 may identify a corresponding object as the charging station, and may identify the corresponding object as an object different from the charging station when the matching score is less than the threshold value.

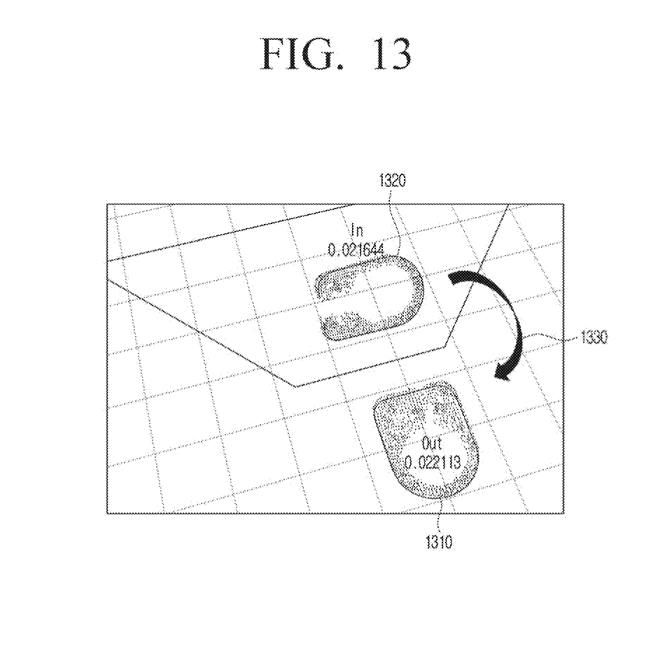

FIG. 13 is a diagram illustrating a process in which the electronic apparatus obtains transformation information according to at least one embodiment.

According to at least one embodiment, the electronic apparatus 100 may obtain transformation information for rotating the point cloud image corresponding to the charging station into the point cloud image corresponding to the first object based on the ICP matching.

The electronic apparatus 100 may identify the first object as the charging station after performing the ICP matching. However, for the electronic apparatus 100 to be docked to the first object, the electronic apparatus 100 may require an accurate docking direction. In this case, the electronic apparatus 100 may obtain the transformation information in a matching process between the point cloud images through the ICP matching. The transformation information may refer to information for rotating and moving the source point cloud image into the target point cloud image.

According to at least one embodiment, the electronic apparatus 100 may identify a docking direction for docking the electronic apparatus 100 to the charging station at a changed location based on the transformation information.

Referring to FIG. 13, the electronic apparatus 100 may obtain transformation information 1330 for transforming a point cloud image 1320 corresponding to the first object into a point cloud image 1310 corresponding to the charging station through the ICP matching.

As illustrated in FIG. 13, to transform the point cloud image 1320 corresponding to the first object into the point cloud image 1310 corresponding to the charging station, the point cloud image 1320 corresponding to the first object may be rotated by 90 degrees in the clockwise direction. Accordingly, the electronic apparatus 100 may obtain the transformation information 1330 corresponding to a 90-degree clockwise rotation.

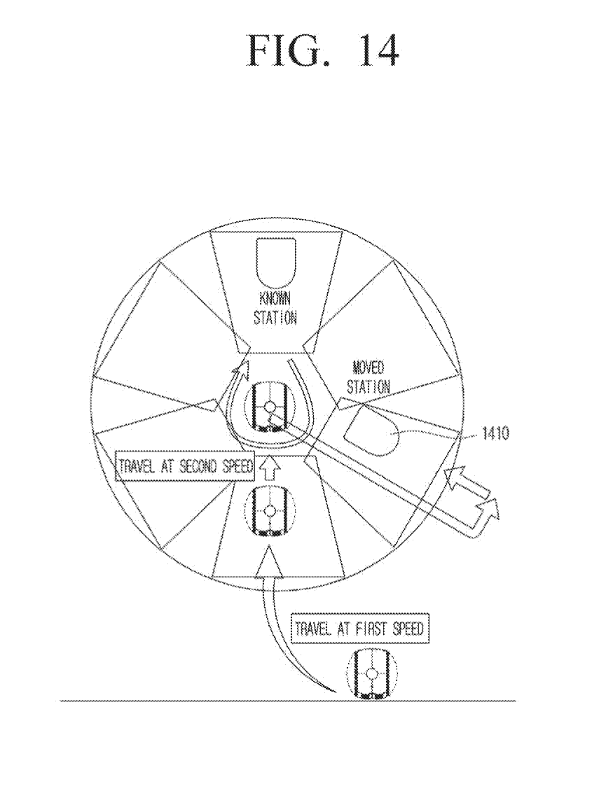

FIG. 14 is a diagram illustrating a process in which the electronic apparatus is docked to the charging station according to at least one embodiment.

According to at least one embodiment, the electronic apparatus 100 may identify a first object 1410 among at least one candidate object as the charging station. The electronic apparatus 100 may identify the docking direction for docking for the electronic apparatus 100 to the first object based on the transformation information obtained based on the result of the ICP matching.

According to at least one embodiment, the electronic apparatus 100 may travel to the first object 1410 in the docking direction, and may be docked to the first object 1410 through a backward travel after rotating by 180 degrees when reaching a front position of first object 1410.

According to at least one embodiment, the electronic apparatus 100 may be docked to the first object through a forward travel when reaching the front position of the first object.

Referring to FIG. 14, the electronic apparatus 100 may identify the docking direction for the first object 1410, and may travel to a location of the first object 1410 in the docking direction. The electronic apparatus 100 may be docked to the first object 1410 through the backward travel after rotating by 180 degrees when reaching the front location of first object 1410.

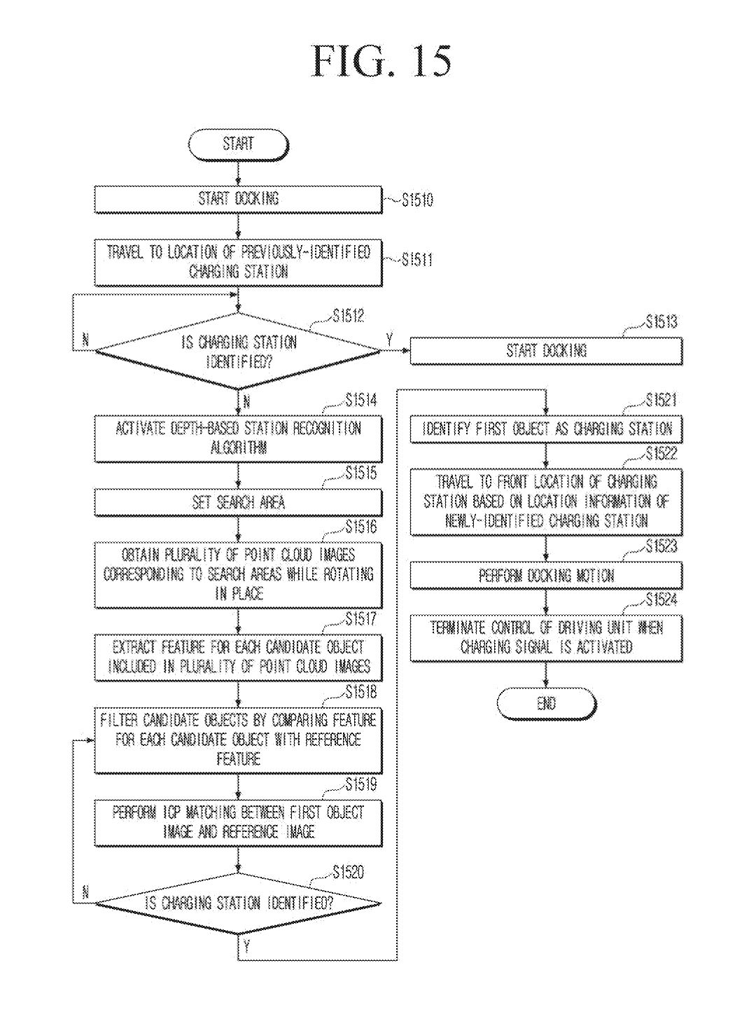

FIG. 15 is a flowchart illustrating an overall operation process of the electronic apparatus according to at least one embodiment.

Referring to FIG. 15, in operation 1510, the electronic apparatus 100 may control the driver 110 to enable the electronic apparatus 100 to be docked to the charging station.

In operation 1511, the electronic apparatus 100 may control the driver 110 to travel to the location of the charging station that is pre-stored in the memory 130. In detail, the electronic apparatus 100 may control the driver 110 to travel at the first speed in the second area and at the second speed in the first area.

In operation 1512, the electronic apparatus 100 may identify whether the charging station is identified at the location of the existing charging station.

In operation 1513 (operation 1512-Y), the electronic apparatus 100 may be docked to the charging station when the charging station is identified at the location of the existing charging station.

In operation 1514 (operation 1512-N), the electronic apparatus 100 may activate a depth-based station recognition algorithm when the charging station is not identified at the location of the existing charging station.

In operation 1515, the electronic apparatus 100 may set the search area based on the sensing range of the sensor 120.

In operation 1516, the electronic apparatus 100 may obtain the plurality of point cloud images corresponding to different search areas while rotating at point "a."

In operation 1517, the electronic apparatus 100 may obtain the feature point information and the direction vector information for each of the plurality of candidate objects included in the plurality of point cloud images.

In operation 1518, the electronic apparatus 100 may filter the candidate objects by comparing information about candidate objects with the reference information.

In operation 1519, the electronic apparatus 100 may perform the ICP matching between the point cloud image corresponding to the first object among the plurality of candidate objects and the point cloud image corresponding to the charging station.

In operation 1520, the electronic apparatus 100 may identify whether the matching score based on the ICP matching is equal to or greater than the threshold value.

In operation 1521 (operation 1520-Y), the electronic apparatus 100 may identify the first object as the charging station when the matching score based on the ICP matching is equal to or greater than the threshold value.

In operation 1522, the electronic apparatus 100 may control the driver 110 to travel to the front location of the charging station based on the location information of a newly-identified charging station.

In operation 1523, the electronic apparatus 100 may perform a docking motion for docking to the charging station.

In operation 1524, the electronic apparatus 100 may terminate control of the driver 110 when a charging signal is activated.

The methods by which the electronic apparatus 100 obtains the feature point information and the direction vector information for each candidate object and performs the ICP matching are described in detail, and their descriptions are thus omitted.

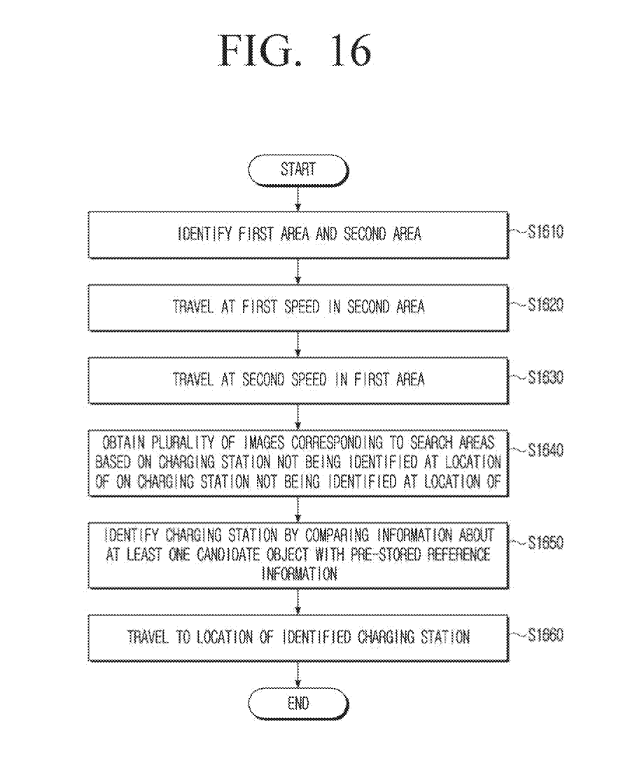

FIG. 16 is a flowchart illustrating a method for operating an electronic apparatus according to at least one embodiment.

Referring to FIG. 16, in operation 1610, the electronic apparatus 100 may identify the first area within the predetermined distance from the location of the existing charging station and the second area outside the first area.

In operation 1620, the electronic apparatus 100 may control the driver 110 to travel at the first speed in the second area while returning to the existing charging station.

In operation 1630, the electronic apparatus 100 may control the driver 110 to travel at the second speed lower than the first speed upon entering the first area.

In operation 1640, based on the charging station not being identified at the location of the existing charging station within the first area, the electronic apparatus 100 may obtain the plurality of images corresponding to different search areas through the sensor 120 while rotating.

In operation 1650, based on at least one candidate object being identified in the plurality of images, the electronic apparatus 100 may identify the charging station among at least one candidate object by comparing the information about at least one candidate object with the pre-stored reference information.

In operation 1660, the electronic apparatus 100 may control the driver 110 to travel to the location of the identified charging station.

A specific method by which the electronic apparatus 100 identifies the first area and the second area and identifies the charging station among at least one candidate object by comparing the information about at least one candidate object and the pre-stored reference information, and a description thereof is thus omitted.

The control method described with reference to FIG. 16 may be performed by the electronic apparatus 100 having the above-described configuration illustrated in FIG. 2. However, the present disclosure is not limited thereto, and the control method may also be performed by an electronic apparatus having various configurations.

The various embodiments described above may be implemented alone, or one or more embodiments may be combined entirely or partially and implemented together in a single device.

According to the various embodiments described above, the electronic apparatus 100 may identify the charging station at a changed location faster and more accurately than when using an IR sensor by utilizing point cloud images through a depth camera.

The various embodiments described above may be applied to a product alone as one embodiment, or at least some of the contents may be implemented in combination with another embodiment of the present disclosure.

The various embodiments described above may be implemented as software including instructions stored in a machine-readable storage medium (e.g., a computer). The machine may load instructions stored in the storage medium and may operate according to the loaded instructions and may include, for example, an electronic apparatus (e.g., the electronic apparatus 100) according to the disclosed embodiments. When the instructions are executed by a processor, the processor may directly perform, or may perform using other components under the control of the processor, functions corresponding to the instructions. The instructions may include code generated or executed by a compiler or an interpreter. The machine-readable storage medium may be provided in the form of a non-transitory computer-readable storage medium. Here, "non-transitory" merely indicates that the storage medium does not include signals and is tangible, and does not distinguish whether data is stored permanently or temporarily.

In addition, according to at least one embodiment of the present disclosure, the methods according to the various embodiments described above may be provided as being included in a computer program product.

In detail, a non-transitory computer-readable storage medium or a computer program product may be provided that stores computer instructions that cause the electronic apparatus to perform the following operations: performing operations of: identifying the first area within the predetermined distance from the location of the existing charging station and the second area outside the first area; traveling at the first speed in the second area while returning to the existing charging station; traveling at the second speed lower than the first speed upon entering the first area; based on the charging station not being identified at the location of the existing charging station within the first area, obtaining the plurality of images corresponding to different search areas while rotating; based on at least one candidate object being identified in the plurality of images, identifying the charging station among at least one candidate object by comparing the information about at least one candidate object with the pre-stored reference information; and traveling to the location of the identified charging station.

The computer program product may be distributed in a form of the machine-readable storage medium (e.g., a compact disc read only memory (CD-ROM)), or may be distributed online via an application store (e.g., PlayStore^{TM}). In case of the online distribution, at least a part of the computer program product may be at least temporarily stored or temporarily generated in the storage medium such as memory of a manufacturer server, an application store server, or a relay server.

In addition, computer instructions or programs for performing the control method of an electronic apparatus or the like according to the various embodiments described above may be stored in a non-transitory computer-readable medium. When executed by a processor of a specific device, the computer instructions stored in such a non-transitory computer-readable medium may cause the specific device to perform the processing operations of the device according to the various embodiments described above. The term "non-transitory computer-readable medium" refers to a medium that temporarily stores data, such as a register, a cache, or a memory, and indicates a medium that semi-permanently stores data and is readable by the device. A specific example of the non-transitory computer-readable recording medium may include a compact disk (CD), a digital versatile disk (DVD), a hard disk, a Blu-ray disk, a universal serial bus (USB), a memory card, a read-only memory (ROM), or the like.

Although the embodiments of the present disclosure have been shown and described hereinabove, the present disclosure is not limited to the above-mentioned specific embodiments, and may be variously modified by those skilled in the art to which the present disclosure pertains without departing from the scope and spirit of the present disclosure as disclosed in the accompanying claims. These modifications should also be understood to fall within the scope and spirit of the present disclosure.

What is claimed is:

1. An electronic apparatus comprising:
a driver configured to move the electronic apparatus;
a sensor;
memory storing instructions; and
at least one processor comprising processing circuitry,
wherein the instructions, when executed by the at least one processor individually or collectively, cause the electronic apparatus to:
identify a first area within a predetermined distance from a location of a charging station,
identify a second area outside the first area,
control the driver to move the electronic apparatus at a first speed in the second area while returning to the charging station,
control the driver to move the electronic apparatus at a second speed lower than the first speed upon entering the first area,
based on the charging station not being identified at the location of the charging station within the first area, obtain a plurality of images corresponding to different search areas through the sensor while rotating the sensor,
based on at least one candidate object being identified in the plurality of images, identify the charging station among the at least one candidate object by comparing information about the at least one candidate object with pre-stored reference information, and
control the driver to move the electronic apparatus to a location of the identified charging station.

2. The electronic apparatus of claim 1, wherein the instructions, when executed by the at least one processor individually or collectively, further cause the electronic apparatus to:
obtain a plurality of point cloud images corresponding to different search areas through the sensor,
based on the at least one candidate object being identified in the plurality of point cloud images, identify a point cloud image corresponding to the at least one candidate object among the plurality of point cloud images,
obtain center point information and direction vector information for the at least one candidate object based on the identified point cloud image, and
identify a first object among the at least one candidate object as the charging station by comparing the center point information and the direction vector information with the pre-stored reference information.

3. The electronic apparatus of claim 2, wherein the reference information comprises point cloud image information and feature point information for the charging station; and
wherein the instructions, when executed by the at least one processor individually or collectively, further cause the electronic apparatus to:
perform Iterative Closest Point (ICP) matching between the identified point cloud image and a point cloud image corresponding to the charging station by inputting the information about the at least one candidate object and the reference information into an ICP algorithm, and
identify the charging station among the at least one candidate object based on a result of the ICP matching.

4. The electronic apparatus of claim 3, wherein the instructions, when executed by the at least one processor individually or collectively, further cause the electronic apparatus to:
perform the ICP matching between a point cloud image corresponding to the first object and the point cloud image corresponding to the charging station and generate an ICP matching score, and
based on the ICP matching score being equal to or greater than a threshold value, identify the first object as the charging station.

5. The electronic apparatus of claim 3, wherein the instructions, when executed by the at least one processor individually or collectively, further cause the electronic apparatus to:
obtain transformation information for rotating the point cloud image corresponding to the charging station into a point cloud image corresponding to the first object based on the ICP matching, and
identify a docking direction for docking the electronic apparatus to the identified charging station based on the transformation information.

6. The electronic apparatus of claim 2, wherein the instructions, when executed by the at least one processor individually or collectively, further cause the electronic apparatus to:
obtain the plurality of point cloud images corresponding to different search areas, respectively, through the sensor,
identify an object that is entirely included in one of the plurality of point cloud images as the at least one candidate object, and
ignore an object that is only partially included in one of the plurality of point cloud images.

7. The electronic apparatus of claim 2, wherein the instructions, when executed by the at least one processor individually or collectively, further cause the electronic apparatus to:
preprocess the identified point cloud image by voxelizing and spatial filtering the identified point cloud image, and
obtain the center point information and the direction vector information for the at least one candidate object based on the preprocessed identified point cloud image.

8. The electronic apparatus of claim 7, wherein the instructions, when executed by the at least one processor individually or collectively, further cause the electronic apparatus to:
identify an average position of all of a plurality of points of the identified point cloud image as the center point information, and
identify the direction vector information based on a point, among the plurality of points, at a highest position in a vertical direction with respect to a ground, and a point, among the plurality of points, at a lowest position in the vertical direction.

9. The electronic apparatus of claim 1, wherein the instructions, when executed by the at least one processor individually or collectively, further cause the electronic apparatus to:
based on the charging station not being identified at the location of the charging station within the first area, obtain obstacle information around the electronic apparatus through the sensor, and
obtain the plurality of images corresponding to different search areas through the sensor while rotating the sensor in a direction with fewer obstacles based on the obstacle information.

10. The electronic apparatus of claim 1, wherein the first area is an area determined based on a sensing range of the sensor, and
wherein the first area and the second area are adjacent to each other.

11. A method of controlling an electronic apparatus, the method comprising:
identifying a first area within a predetermined distance from a location of a charging station;
identifying a second area outside the first area;
moving the electronic apparatus at a first speed in the second area while returning to the charging station;
moving the electronic apparatus at a second speed lower than the first speed upon the electronic apparatus entering the first area;
based on the charging station not being identified at the location of the charging station within the first area, obtaining a plurality of images corresponding to different search areas while rotating the sensor;
based on at least one candidate object being identified in the plurality of images, identifying the charging station among the at least one candidate object by comparing information about the at least one candidate object with pre-stored reference information; and
moving the electronic apparatus to a location of the identified charging station.

12. The method of claim 11, further comprising:
obtaining a plurality of point cloud images corresponding to different search areas through a sensor of the electronic apparatus while rotating the sensor;
based on the at least one candidate object being identified in the plurality of point cloud images, identifying a point cloud image corresponding to the at least one candidate object among the plurality of point cloud images;
obtaining center point information and direction vector information for the at least one candidate object based on the identified point cloud image; and
identifying a first object among the at least one candidate object as the charging station by comparing the center point information and the direction vector information with the pre-stored reference information.

13. The method of claim 12, wherein the reference information comprises point cloud image information and feature point information for the charging station, and
wherein the method further comprises:
performing Iterative Closest Point (ICP) matching between the identified point cloud image and a point cloud image corresponding to the charging station by inputting the information about the at least one candidate object and the reference information into an ICP algorithm; and
identifying the charging station among the at least one candidate object based on a result of the ICP matching.

14. The method of claim 13, further comprising:
performing the ICP matching between a point cloud image corresponding to the first object and the point cloud image corresponding to the charging station and generate an ICP matching score; and
based on the ICP matching score being equal to or greater than a threshold value, identifying the first object as the charging station.

15. The method of claim 13, further comprising:
obtaining transformation information for rotating the point cloud image corresponding to the charging station into a point cloud image corresponding to the first object based on the ICP matching; and
identifying a docking direction for docking the electronic apparatus to the identified charging station based on the transformation information.

16. The method of claim 12, further comprising:
obtaining the plurality of point cloud images corresponding to different search areas, respectively, through the sensor;
identifying an object that is entirely included in one of the plurality of point cloud images as the at least one candidate object; and
ignoring an object that is only partially included in one of the plurality of point cloud images.

17. A non-transitory computer readable storage medium storing computer instructions that, when executed by at least one processor of an electronic apparatus, cause the electronic apparatus to perform a method of controlling the electronic apparatus, the method comprising:
identifying a first area within a predetermined distance from a location of a charging station;
identifying a second area outside the first area;
moving the electronic apparatus at a first speed in the second area while returning to the charging station;
moving the electronic apparatus at a second speed lower than the first speed upon the electronic apparatus entering the first area;
based on the charging station not being identified at the location of the charging station within the first area, obtaining a plurality of images corresponding to different search areas while rotating the sensor;
based on at least one candidate object being identified in the plurality of images, identifying the charging station among the at least one candidate object by comparing information about the at least one candidate object with pre-stored reference information; and
moving the electronic apparatus to a location of the identified charging station.

18. The non-transitory computer readable storage medium of claim 17, wherein the method further comprises:
obtaining a plurality of point cloud images corresponding to different search areas through a sensor of the electronic apparatus while rotating the sensor;
based on the at least one candidate object being identified in the plurality of point cloud images, identifying a point cloud image corresponding to the at least one candidate object among the plurality of point cloud images;
obtaining center point information and direction vector information for the at least one candidate object based on the identified point cloud image; and
identifying a first object among the at least one candidate object as the charging station by comparing the center point information and the direction vector information with the pre-stored reference information.

19. The non-transitory computer readable storage medium of claim 18, wherein the reference information comprises point cloud image information and feature point information for the charging station, and
wherein the method further comprises:
performing Iterative Closest Point (ICP) matching between the identified point cloud image and a point cloud image corresponding to the charging station by inputting the information about the at least one candidate object and the reference information into an ICP algorithm; and
identifying the charging station among the at least one candidate object based on a result of the ICP matching.

20. The non-transitory computer readable storage medium of claim 19, wherein the method further comprises:
performing the ICP matching between a point cloud image corresponding to the first object and the point cloud image corresponding to the charging station and generate an ICP matching score; and
based on the ICP matching score being equal to or greater than a threshold value, identifying the first object as the charging station.
